(19) United States
(12) Patent Application Publication
(10) Pub. No.: US 2006/0168747 A1
(43) Pub. Date: Aug. 3, 2006

(54) Pipe-cleaning system with safety device

(76) Inventor: Dietmar Krehl, Dortmund (DE)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(21) Appl. No.: 10/548,977

(22) PCT Filed: Feb. 23, 2004
(86) PCT No.: PCT/EP04/01773

§ 371 Date: Sep. 13, 2005

(30) Foreign Application Priority Data
Mar. 13, 2003 (DE) 103 11 066.6

(51) Int. Cl. B08B 9/053

(52) U.S. Cl. 15/104.062

(57) ABSTRACT

In a pipe-cleaning system for sludge pumps, which comprises an importation station that is installed in a delivery line and has a movable component driven by an external drive for introducing a cleaning element into the delivery line, the safety means include, according to the invention, at least one switching element that registers the insertion or removal process and at least one switching means actuated by said switching element, said switching means preventing movement of the movable component by the external drive in the event of the at least one switching element being in a state or generating a signal representative of an insertion or removal process.

This invention relates to a pipe-cleaning system for delivery lines, having the features of the preamble of claim 1. In the narrower sense, it relates to a safety device for users of the pipe-cleaning system, and to delivery lines fed by sludge pumps.

Sludge pumps have been used to convey concrete, in particular, for a long time. As a rule, they are configured as hydraulically operated piston pumps, usually twin-cylinder pumps, which convey the concrete through hoses or pipes. In the following, for the sake of simplicity, reference will always be to concrete conveyance. However, the invention is not restricted to use with concrete pumps, but may be used for all similar pipe-cleaning systems involving sludge pumps.

A special version of these concrete pumps is mounted on trucks fitted with a boom or the like. Concrete pumps of this kind are of particular interest in connection with the invention, since with these pumps, there is the problem that on completion of a pumping, i.e., conveying operation, residual concrete in the delivery lines must be blown out therefrom with the boom extended, thus clearing the lines for the next pour. Depending on the position, length and height of the boom and delivery lines, pump discharge pressures of up to 10 bar are encountered.

It is known (DE-A1-29 27 324) that for this purpose, a wiping or cleaning element can be introduced into the delivery line, this element being so dimensioned that it essentially fills out the cross-section of the delivery line and may be driven by fluid pressure (especially air pressure) through the entire length of the delivery line. As it moves through the line, it pushes the sludge in front of it. In most cases, a ball-shaped cleaning element of relatively soft material (e.g. rubber) is used, which makes a good seal with the pipeline walls. In the following, the cleaning element will thus always be referred to as a ball, without thereby precluding other shapes and materials.

To introduce the ball into delivery line engineered to withstand relatively high pressures, the line must be temporarily opened. A preferred embodiment of a device for introducing the ball into the delivery line consists in an importation station installed permanently in the delivery line, directly at the pump outlet. The importation station is engineered preferably as a hydraulically operated dual-chamber slide. During normal pump operation, one slide chamber is located in the delivery line, i.e. it forms a short section of the delivery line itself. The other slide chamber, by contrast, is located outside the delivery line in a loading position, and the ball can be inserted into it by hand.

To clean out residual sludge/concrete from the delivery line, the slide chamber containing the ball is moved by external force into the position of the first chamber. This operation requires a considerable amount of force, as gravity may be causing the column of sludge in the delivery line to press on the side walls of the slide. The slide is preferably moved back and forth with the help of a hydraulically operated differential cylinder, but other reversible drives, e.g. electric drives, are also possible. As a result, the ball is moved into the delivery line, while the first chamber is now located outside the delivery line, where it may, if necessary, be emptied and cleaned. A small section of the line still filled with the hitherto conveyed sludge is thus replaced by a sludge-free section containing only the ball for clearing the delivery line.

During the customary manual insertion of the ball there is a certain risk of the slide's external drive being switched on unintentionally. If this happens despite all the safety information that is naturally contained in the operating manual, the hand of the person inserting the ball is endangered. To ensure that the line is leakproof irrespective of which line section of the slide is operative at any one moment, firm sealing edges have to be provided, along which the slide is guided.

It is known (SCHWING GmbH's operator's manual for Item No. 101 98 516), that accidents of this kind can be prevented by providing a safety detent with mechanically/manually operated slides in the hydraulic installation. However, operator errors can not be ruled out with this system, either.

It would also be conceivable to configure the insertion opening in such manner as to prevent one from reaching into the endangered zone with one's hand, for example, by attaching an adequately long pipe to the opening, through which the ball can roll in by itself or be forced in by an additional device. However, an arrangement of such kind would make it difficult to remove the ball and would unsuitably enlarge the necessary compact design.

The problem addressed by the invention is thus to develop a pipe-cleaning system of like kind and including a safety device in such manner that danger to the operator while inserting the cleaning element can be practically be ruled out.

This problem is solved according to the invention with the features of claim 1. The features of the subclaims represent useful developments of the invention.

In implementing the invention it must be remembered that sludge pumps, especially concrete pumps, have to withstand extremely harsh service conditions with a high degree of soiling, and that operating instructions and safety regulations may not always be observed.

All safety devices must therefore be sturdy and reliable and must, if necessary, be of redundant design.

It would by all means be conceivable, for example, to provide a light barrier or other directly acting sensors (infrared, ultrasonic) in the ball insertion area, which detect every object that comes into the vicinity of the slide or the monitored openings. In the event of a detection signal from the sensor, operation of the importation station's external drive will be directly or indirectly interrupted. To this end, electrically/electromagnetically switched safety valves, for example, may be installed especially for this purpose in the hydraulic or pneumatic circuit of the actuating cylinder, or else existing valves of such kind may be deactivated in a suitable manner. Of course, it is preferable to configure a shut-off or safety valve of this kind in such manner that it is normally closed and prevents the supply of pressure medium to the actuating cylinder, that is, to the insertion-station drive. The shut-off valve may be configured to act directly or indirectly, i.e. it may be connected into an existing actuating-cylinder feed circuit or it may be configured as a control valve that actuates a main valve.

An electric drive may be deactivated even more easily by cutting off its power supply if the safety device reacts. Here too, directly or indirectly acting switching means (relay, electronic) may be provided.

With sensor arrangements of this kind, however, which are relatively delicate, a certain risk of damage and/or impaired functioning under harsh construction-site conditions can not be permanently ruled out.

Accordingly, in a preferred embodiment—to be explained in even more detail—of the invention, the importation station is provided with at least one movable closure member whose position is mechanically detected by means of at least one switching element. The closure member is preferably mounted such that it can and must be opened manually in order to insert the ball into the importation station, and must be closed after the ball has been inserted.

The closure member is preferably configured as a pivotable or slidable shutter that closes off the ball-insertion opening completely or at least far enough to prevent a foreign body from getting through the opening when the shutter is in the closed position. However, it would also be conceivable to provide a removable shutter.

If this closure member is in an even partly open position, the switching element responds and prevents operation of the external drive.

The switching element may be a switch, a sensor or also a valve. It changes its state depending on the position of the closure member, i.e. a sensor or switch will generate a signal, or a valve acting as switching element will be closed or opened. The switching element and the switching means may thus be one and the same thing, since a valve, as a perfect example, may both detect a certain position and, in this position, influence the operation of the external drive.

The switching element may also be provided on a device for locking the closure member, so that it will respond even if the closure member has merely been unlocked and there is accordingly a possibility of its being moved from the closed into the open position.

In a useful development of the pipe-cleaning system according to the invention, not only the opening for inserting or removing the ball is monitored but, if necessary, also the area into which, once the ball has been inserted, the other chamber of the importation station is moved. The same risk of injury, namely, will always exist there if this chamber is moved into a space which, for example, is not completely enclosed by a protective cover. It may be to advantage, for example, if a protective cover of this kind is not of completely closed design, thus permitting easy cleaning of the line section moved into it.

Here, a safety device according to the invention can prevent body parts from being squashed between the outer wall of the outwardly-moving pipe chamber and the aforementioned protective cover; during cleaning work, it will also prevent any actuation or reversal of the drive for returning the importation station to the other position.

This area can likewise be provided, for example, with a movable closure member whose closure state is monitored directly or indirectly by a switching element. If this switching element signalizes that the closure member is open or has been removed, the external drive is deactivated or blocked.

It goes without saying that the system according to the invention can be used not only for importation stations with linear-motion components, but also for stations with rotary-motion components, for example.

It is also possible to advantageously combine several of the safety elements discussed above in order to form a redundant system if required. For example, even if a closure member has been fitted, it is possible to additionally provide a sensor for the contact-free detection of an object or body part in the danger zone.

Further details and advantages of the subject of the invention are apparent from the simplified drawings of an embodiment and the subsequent detailed description thereof that follows.

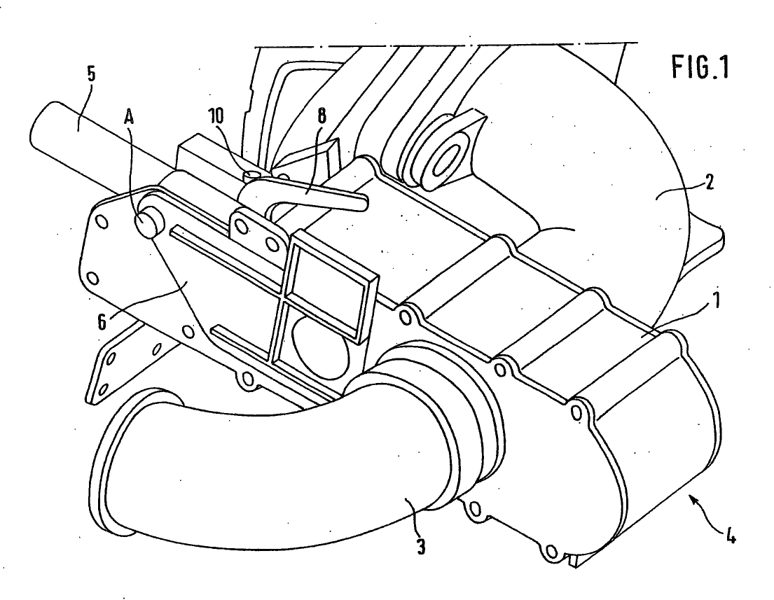

FIG. 1 shows a first perspective view of an importation station for a pipe-cleaning system according to the invention, with the closure shutter closed;

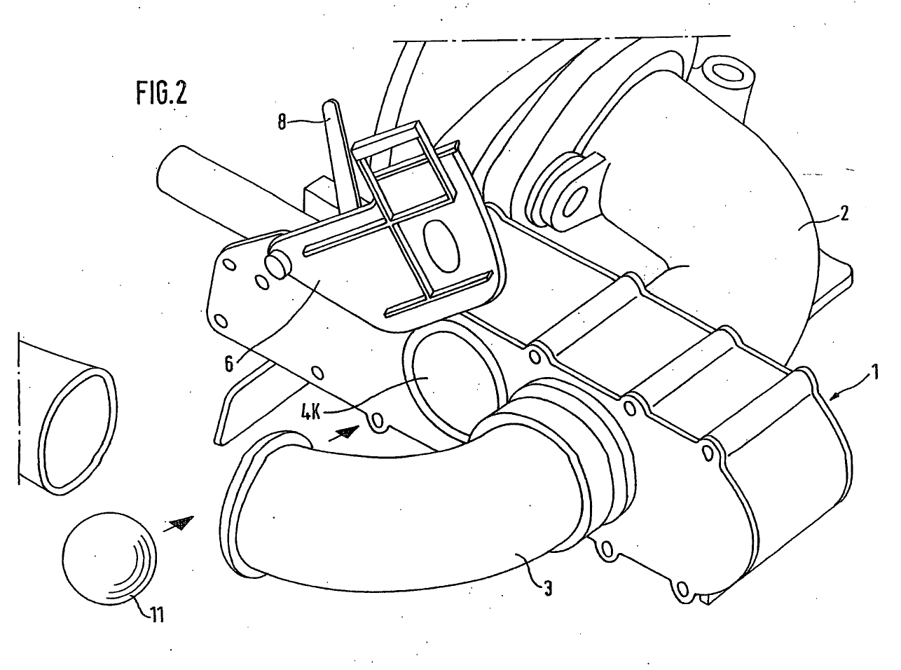

FIG. 2 shows a second view similar to that of FIG. 1, with the closure shutter open;

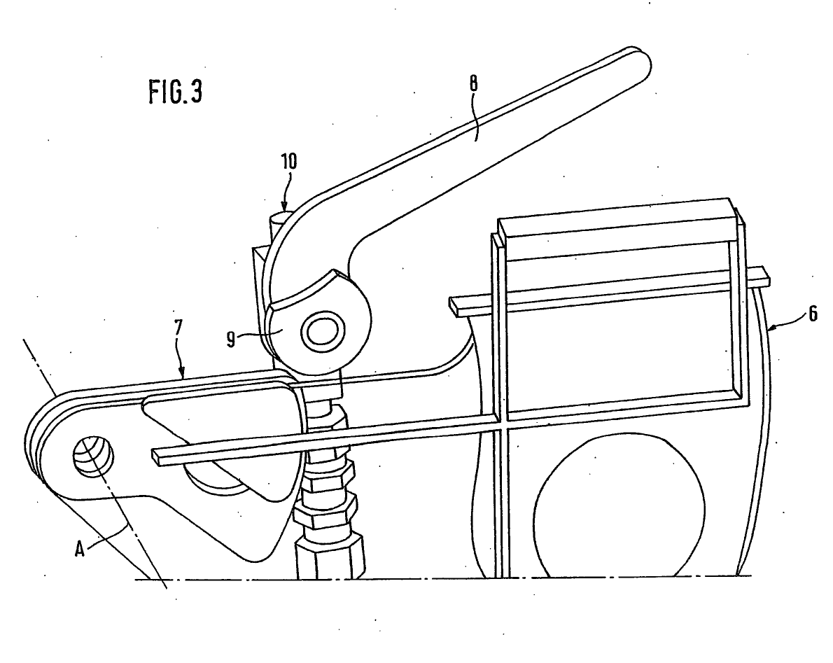

FIG. 3 shows a detailed view of the closure shutter of FIG. 1 and of its safety mechanism;

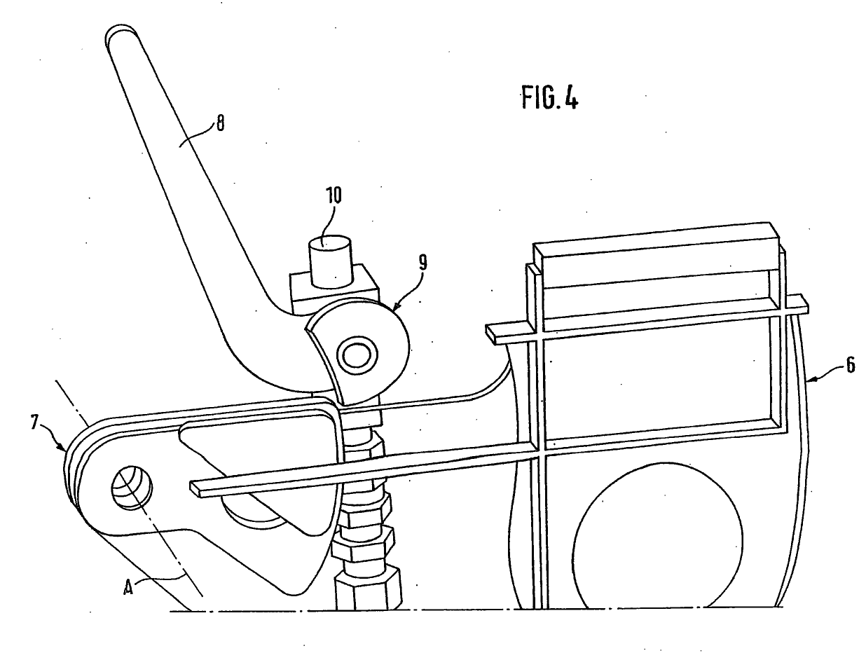

FIG. 4 shows another detailed view after the closure shutter has been unlocked;

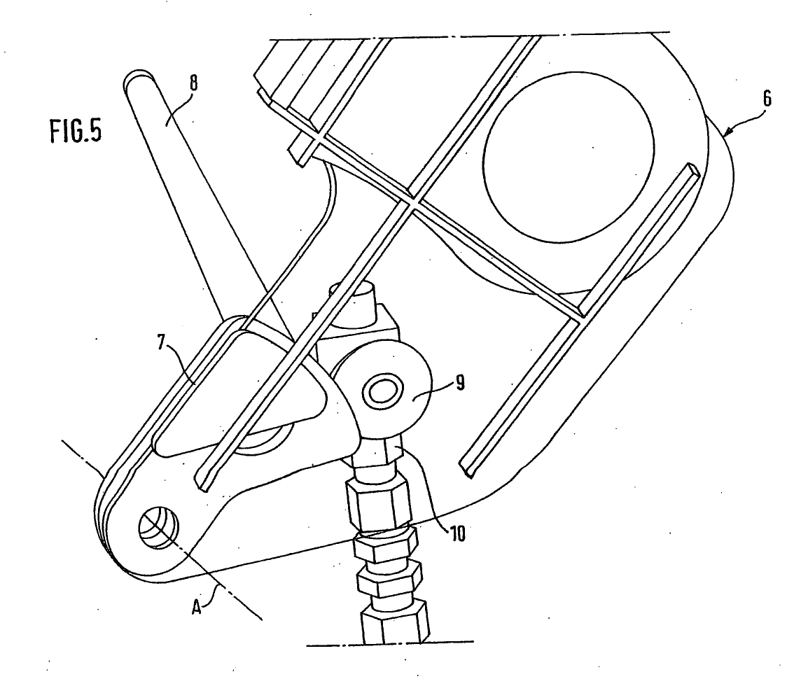

FIG. 5 shows a detailed view of the open closure shutter of FIG. 2, with the operation of the insertion-station drive being actively prevented.

As shown in FIG. 1, an importation station 1 installed downstream of a sludge pump that is not shown comprises a reducer bend 2 on the inlet side (between the pump and the importation station 1), a pipe bend 3 on the outlet side (to which the delivery line to be cleaned—not shown here—connects) and a slide casing 4 that has a hydraulic actuating cylinder 5 at the drive end and a closure shutter 6. The latter is mounted on the slide casing 4 such that it is pivotable about an axis A, and is shown here in the closed position.

Above the closure shutter 6 a pivoted safety lever 8 is also visible, which in turn acts directly on a valve 10. The latter forms a switching element for detecting an open position of the closure shutter 6. When the safety lever 8 is in the locking position as shown, the valve is open and permits the supply of pressure medium to the actuating cylinder 5 (operative position).

FIG. 2 shows the same view as FIG. 1, here with the closure shutter 6 open. Behind it, the pipe-shaped chamber 4K is visible, into which a ball 11 may be inserted, which, after the closure shutter 6 has been closed and the chamber 4K moved into position between the pipe elbows 2 and 3, may be pushed through the delivery line by a pressure medium in order to blow out the line and clean it. It is also evident from FIG. 2 that the safety lever 8 has been swung upwards to release the closure shutter 6. The switching element, or the valve 10, is now closed and interrupts the supply of pressure medium to the actuating cylinder 5. The swung-up position of the safety lever 8 creates a state that represents the insertion or removal process.

At the opposite end of the importation station to the actuating cylinder 5—in the drawing at the bottom right—a closed space is visible into which, when the chamber 4K is slid into the delivery line, the chamber or line section that is normally in the delivery line is transferred.

In a manner not shown, a closure member to be provided for this space—like the closure shutter 6 for the importation station 4—could be monitored by means of a switching element in order to largely rule out the risk of injury in this area, too.

FIG. 3 is a detail showing a possible arrangement of the closure shutter 6, the safety lever 8 and the switching valve 10. The axis A of the closure shutter 6 is again evident. A gate element 7 is permanently mounted on the shutter side facing the safety lever 8. The gate element is of roughly triangular outline, with the side of the triangle facing away from the axis A of the shutter closure 6 being convex.

The gate element 7 is in the same plane as a sickle-shaped disk 9 mounted on the safety lever 8. The disk 9 is essentially circular, with a segment cut out of it. The centre point of the sickle-shaped disk 9 coincides with the pivoting axis of the safety lever 8. The cutting line of the segment cut out of the circular disk is slightly concave. It has approximately the same radius of curvature as the convex side of the triangular gate element 7.

In FIG. 3 it is evident that the gate element 7 would run up against the sickle-shaped disk 9 if the closure shutter 6 were to be swung up around its axis A. The closure shutter 6 is thus safely locked in this position by mechanical means, and no access to the chamber 4K is possible. Even if the safety lever were to be raised slightly, the locked condition of the closure shutter 6 would not change.

FIGS. 4 and 5 show, in a similar way to FIG. 2, the safety lever 8 after it has been swung up anti-clockwise by about 90° out of the locking position. It is evident that the curvature of the convex side of the of the gate element 7 continues in the concave line along which the segment was cut out of the sickle-shaped disk 9. Only when the safety lever 8 is in this position, in which the valve 10 is closed, can the closure shutter 6 be raised.

When the shutter is raised, the convex side of the triangular gate element 7 slides along the concave cutting line of the segment cut out of the sickle-shaped disk 9, as can be seen in FIG. 5, which also shows the final position reached by the closure shutter 6 when it is swung upwards. The convex side of the triangular gate element abuts against the concave cut side of the sickle-shaped disk 9 such that the safety lever 8 is prevented from turning for as long as the closure shutter 6 is in the swung-up position. In consequence, the valve 10 can not be opened again while the closure shutter 6 is open, thus preventing any operation of the actuating cylinder 5.

The closure shutter 6 may be pivoted in such manner that it closes automatically under the influence of gravity when let go. To insert the ball, the user must hold the closure shutter 6 open with one hand and insert the ball with the other.

However, an arrangement is also possible whereby the closure shutter 6 engages in the raised position and requires slight pressure to push it down into the closed position.

Instead of the closure shutter 6 being pivotable about the axis of rotation A, which, as shown here, is horizontal in the fitting position, other configurations are also possible; provision may be made, for example, for a closure shutter to be pivotable about a vertical axis, or to be pushed in a straight line or along an arc. It would also be possible to provide a removable closure shutter. Which variant will ultimately be implemented will depend primarily on the amount of space available for moving parts under the respective installation constraints.

Further, in place of the purely mechanical sensing—as shown here—of the closure and locked position of the closure shutter 6 by means of the safety lever 8 and the valve 10, electromechanical, electrical or electronic variants are conceivable, too, as already mentioned at the beginning.

For example, if the operation of the actuating cylinder 5 is controlled by means of electrically switchable valves that are closed when the cylinder is in the inoperative position, the power supply to these valves can be interrupted by way of an electric switching element that monitors the position of the closure shutter 6 or of the safety lever 8. In consequence, no pressure medium can reach the cylinder for as long the closure shutter 6 is open or the safety lever 8 raised.

1. A pipe-cleaning system for delivery lines, having an importation station (4) that comprises a component, in particular a slide, that is movable by an external drive (5) and has a chamber (4K) for insertion of a cleaning element (11), said chamber (4K) being located—in a first position—outside a delivery line (2, 3) and being movable by means of the external drive into a second position in order to introduce the cleaning element (11) placed in it into the delivery line, a safety means (6, 8, 10) being provided to prevent the movable component from being moved by the external drive during insertion and/or removal of the cleaning element (11), characterised in that the safety means comprises at least one switching element (8) that registers the insertion or removal process and at least one switching means (10) that can be actuated by said switching element (8) and that prevents the chamber (4K) from being moved by the external drive (5) in the event of the at least one switching element (8) being in a state or generating a signal representative of an insertion or removal process.

2. A pipe-cleaning system according to claim 1, characterised in that the switching element is formed by at least one sensor for detecting the presence of an object in the vicinity of the insertion opening.

3. A pipe-cleaning system according to claim 1, characterised in that the safety means comprises at least one movable closure member (6) which can be removed from an inoperative position for insertion or removal of the cleaning element (11), and in that at least one switching element (10) is provided which detects a closure-member—position deviating from the inoperative position and which rules out activation of the external drive (5) in this position.

4. A pipe-cleaning system according to claim 3, characterised in that the closure member (6) is engineered as the cover or shutter which closes the insertion or removal opening for the cleaning element (11).

5. A pipe-cleaning system according to claim 3, characterised in that at least one safety member (8) is provided for locking the closure member (6) in its closed position, and that at least one switching element (10) is provided for detecting the position of the safety member (8), said switching element (10) ruling out activation of the external drive while the safety member (8) is in the non-locking position.

6. A pipe-cleaning system according to claim 1, characterised in that the safety means also comprises at least one additional switching element for monitoring a transfer area into which the movable component of the importation station is transferred when it is moved into its second position, the additional switching element directly or indirectly preventing operation of the external drive if, in the transfer area,
an object is detected and/or
a closure member that prevents access to the transfer area is not in its closed position and/or
a safety component provided to secure the closure member that closes off the access to the transfer area is in a non-locking position.

7. A pipe-cleaning system according to claim 3, characterised in that the closure member is configured as a shutter (6) that is pivotable about an axis (A) and whose closed position is lockable by means of a safety lever (8), the safety lever (8) acting as a switching element and actuating a switching means (10) which blocks the external drive (5) when the safety lever is in a non-locking position.

8. A pipe-cleaning system according to claim 7, characterised in that the safety lever (8) and the closure shutter (6) are mutually mechanically lockable by means of a gate-type mechanism (7, 9).

9. A pipe-cleaning system according to claim 1, characterised in that at least one switching element (10) is configured as a switchable valve which, acting simultaneously as a switching element which directly or indirectly prevents the supply of pressure medium to the hydraulic or pneumatic external drive (5) when in a switching position representative of the insertion or removal process.

10. A pipe-cleaning system according to claim 9, characterised in that the valve (10) is mechanically, electromechanically or electromagnetically switchable.

11. A pipe-cleaning system according to claim 1, characterised in that at least one switching element is configured as an electric switch, which, when in a switching position representative of the insertion or removal process, directly or indirectly interrupts the power supply to an electric external drive.

12. A pipe-cleaning system according to claim 1, in combination with a sludge pump having a delivery line and a pipe-cleaning system, wherein said pipe-cleaning system is installed in the delivery line.

13. A pipe-cleaning system according to claim 2, characterised in that the safety means comprises at least one movable closure member (6) which can be removed from an inoperative position for insertion or removal of the cleaning element (11), and in that at least one switching element (10) is provided which detects a closure-member-position deviating from the inoperative position and which rules out activation of the external drive (5) in this position.

14. A pipe-cleaning system according to claim 13, characterised in that the closure member (6) is engineered as the cover or shutter which closes the insertion or removal opening for the cleaning element (11).

15. A pipe-cleaning system according to claim 4, characterised in that at least one safety member (8) is provided for locking the closure member (6) in its closed position, and that at least one switching element (10) is provided for detecting the position of the safety member (8), said switching element (10) ruling out activation of the external drive while the safety member (8) is in the non-locking position.

16. A pipe-cleaning system according to claim 3, characterised in that the safety means also comprises at least one additional switching element for monitoring a transfer area into which the movable component of the importation station is transferred when it is moved into its second position, the additional switching element directly or indirectly preventing operation of the external drive if, in the transfer area,
an object is detected and/or
a closure member that prevents access to the transfer area is not in its closed position and/or
a safety component provided to secure the closure member that closes off the access to the transfer area is in a non-locking position.

17. A pipe-cleaning system according to claim 5, characterised in that the closure member is configured as a shutter (6) that is pivotable about an axis (A) and whose closed position is lockable by means of a safety lever (8), the safety lever (8) acting as a switching element and actuating a switching means (10) which blocks the external drive (5) when the safety lever is in a non-locking position.

18. A pipe-cleaning system according to claim 17, characterised in that the safety lever (8) and the closure shutter (6) are mutually mechanically lockable by means of a gate-type mechanism (7, 9).

19. A pipe-cleaning system according to claim 3, characterised in that at least one switching element is configured as an electric switch, which, when in a switching position representative of the insertion or removal process, directly or indirectly interrupts the power supply to an electric external drive.

20. A pipe-cleaning system according to claim 7, characterised in that at least one switching element is configured as an electric switch, which, when in a switching position representative of the insertion or removal process, directly or indirectly interrupts the power supply to an electric external drive.
